(19) United States
(12) Patent Application Publication
(10) Pub. No.: US 2015/0234571 A1
(43) Pub. Date: Aug. 20, 2015

(54) RE-PERFORMING DEMONSTRATIONS DURING LIVE PRESENTATIONS

(71) Applicant: Microsoft Corporation, Redmond, WA (US)

(72) Inventors: Bongshin Lee, Issaquah, WA (US); Steven Mark Drucker, Bellevue, WA (US); Pei-Yu Chi, Berkeley, CA (US)

(73) Assignee: Microsoft Corporation, Redmond, WA (US)

(21) Appl. No.: 14/181,996

(22) Filed: Feb. 17, 2014

(51) Int. Cl. G06F 3/0484; G06F 3/0485

(52) U.S. Cl. CPC G06F 3/04842; G06F 3/0485

(57) ABSTRACT

A sequence of low-level user input events that takes place during a demonstration is converted into a sequence of high-level events which is used to identify portions of a screencast video of the demonstration as event portions. A presenter rehearses, edits, and re-performs the demonstration during a live presentation by playing back an augmented version of the video that is generated on-the-fly and during at least one point in time includes visualizations of the current and next high-level events that are automatically overlaid on top of the video at the screen locations where these events takes place. A graphical user interface that includes a video sector and a timeline sector is displayed to the presenter. The augmented version of the video is played back within the video sector. An event timeline that includes an overall timeline showing each of the portions of the video is displayed within the timeline sector.

### BACKGROUND

A presenter who is giving a live presentation to an audience often times performs and narrates a demonstration during the presentation. For example, a presenter who is giving a live presentation about a new software application often times gives the audience a demonstration of the application and its features during the presentation. By demonstrating real-world user interactions with the software application (e.g., by guiding the audience through exemplary user inputs and showing the audience the results thereof), the presenter can demonstrate various features of the application to the audience. As such, performing and narrating a demonstration during a live presentation can be an effective way to communicate with the audience and keep them engaged.

Sometimes a presenter will perform and narrate a live demonstration for an audience, which can be very effective and engaging. However, performing and narrating a live demonstration can also be very risky since the presenter can encounter many different and unexpected issues during a live demonstration, where these issues can significantly decrease the demonstration's effectiveness and its ability to keep the audience engaged. Such issues include the presenter forgetting the sequence of steps to be performed during a live demonstration, and/or forgetting the narration content that is to be spoken in conjunction with each of these steps, and/or forgetting to demonstrate certain features. In the case where the presenter is performing and narrating a live demonstration of a software application on a real working computer system, such issues also include software crashes and hangs resulting from the software application being buggy and thus unstable, computer system failures, mismatched display screen resolutions, and unreliable network connectivity, to name a few. Furthermore, even if none of these issues winds up occurring when performing a live demonstration, the presenter often worries about the possible occurrence of one or more of these issues and can thus become distracted from the live demonstration. As a result, during a live demonstration the audience may need to wait for system problems to be resolved and may also see the presenter rambling, thus making the live demonstration ineffective and causing the audience to become disengaged. The just-described live demonstration issues can be addressed by the presenter playing back a previously recorded screencast video of the demonstration to the audience.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

Demonstration re-performing technique embodiments described herein are generally applicable to allowing presenters to re-perform demonstrations during live presentations. In one exemplary embodiment user input events in a screencast video of a demonstration are identified as follows. The screencast video is input, and data associated with a sequence of low-level user input events that takes place during the demonstration is also input. The sequence of low-level user input events is then converted into a sequence of high-level user input events. Portions of the screencast video are then identified as either event portions or inactive portions, where this identification includes mapping each of the high-level user input events to a different event portion, and mapping each gap in time that exists between two consecutive high-level user input events to a different inactive portion.

In another exemplary embodiment a presenter is allowed to rehearse and edit a demonstration. A screencast video of the demonstration is input. Metadata that is associated with a sequence of high-level user input events that takes place during the demonstration is also input, where this metadata identifies portions of the screencast video as either event portions or inactive portions, each of the high-level user input events is mapped to a different event portion, and each gap in time that exists between two consecutive high-level user input events is mapped to a different inactive portion. Metadata that is associated with each of the portions is also input. Upon receiving a request from the presenter to playback the screencast video, an augmented version of the screencast video is played back to the presenter on a display device. This augmented version is generated on-the-fly as the screencast video is being played back, and during at least one point in time during this playback this augmented version includes a visualization of the current high-level user input event that is automatically overlaid on top of the screencast video at the screen location where the current high-level user input event takes place, and a visualization of the next high-level user input event that is automatically overlaid on top of the screencast video at the screen location where the next high-level user input event takes place.

In yet another exemplary embodiment the presenter is allowed to re-perform the demonstration during a live presentation to an audience. A screencast video of the demonstration is input. Metadata that is associated with the sequence of high-level user input events that takes place during the demonstration is also input, where this metadata identifies portions of the screencast video as either event portions or inactive portions, each of the high-level user input events is mapped to a different event portion, and each gap in time that exists between two consecutive high-level user input events is mapped to a different inactive portion. A video playback graphical user interface (GUI) is then displayed on a private display device that just the presenter is able to see, where this GUI includes a video sector and a timeline sector. Upon receiving a request from the presenter to playback the screencast video, the following actions occur. An augmented version of the screencast video is played back within the video sector, where during at least one point in time during this playback this augmented version includes a visualization of the current high-level user input event and a visualization of the next high-level user input event. An event timeline is displayed within the timeline sector, where the event timeline includes an overall timeline that shows each of the event portions and each of the inactive portions of the screencast video.

### DESCRIPTION OF THE DRAWINGS

The specific features, aspects, and advantages of the demonstration re-performing technique embodiments described herein will become better understood with regard to the following description, appended claims, and accompanying drawings where:

FIG. 1 is a diagram illustrating an exemplary embodiment, in simplified form, of a lightweight workflow for allowing a presenter to re-perform a demonstration during a live presentation.

FIGS. 2A-2F are diagrams illustrating exemplary embodiments, in simplified form, of different glyphs that can be used to represent different types of high-level user input events.

FIGS. 3A-3C are diagrams illustrating exemplary embodiments, in simplified form, of different types of motion-arrow glyphs.

FIG. 4 is a diagram illustrating an exemplary embodiment, in simplified form, of a straight motion-arrow glyph that includes a progress bar embedded there-within.

FIG. 5 is a diagram illustrating an exemplary embodiment, in simplified form, of a countdown version of a single-click glyph that visually conveys the specific timing of when an impending single-click event will start.

FIGS. 6A-6D are diagrams illustrating exemplary embodiments, in simplified form, of the visualization of four different high-level user input event sequences.

FIG. 7 is a diagram illustrating an exemplary embodiment, in simplified form, of a generalized layout for a video playback graphical user interface that allows the presenter to rehearse and edit the demonstration, and also to re-perform the demonstration during a live presentation to an audience.

FIG. 8 is a flow diagram illustrating an exemplary embodiment, in simplified form, of a process for identifying user input events in a screencast video of the demonstration.

FIG. 9 is a flow diagram illustrating an exemplary embodiment, in simplified form, of a process for allowing the presenter to rehearse and edit the demonstration.

FIG. 10 is a flow diagram illustrating an exemplary embodiment, in simplified form, of a process for allowing the presenter to re-perform the demonstration during a live presentation to an audience.

FIG. 11 is a diagram illustrating a simplified example of a general-purpose computer system on which various embodiments and elements of the demonstration re-performing technique, as described herein, may be implemented.

### DETAILED DESCRIPTION

In the following description of demonstration re-performing technique embodiments reference is made to the accompanying drawings which form a part hereof, and in which are shown, by way of illustration, specific embodiments in which the demonstration re-performing technique can be practiced. It is understood that other embodiments can be utilized and structural changes can be made without departing from the scope of the demonstration re-performing technique embodiments.

It is also noted that for the sake of clarity specific terminology will be resorted to in describing the demonstration re-performing technique embodiments described herein and it is not intended for these embodiments to be limited to the specific terms so chosen. Furthermore, it is to be understood that each specific term includes all its technical equivalents that operate in a broadly similar manner to achieve a similar purpose. Reference herein to “one embodiment”, or “another embodiment”, or an “exemplary embodiment”, or an “alternate embodiment”, or “one implementation”, or “another implementation”, or an “exemplary implementation”, or an “alternate implementation” means that a particular feature, a particular structure, or particular characteristics described in connection with the embodiment or implementation can be included in at least one embodiment of the demonstration re-performing technique. The appearances of the phrases “in one embodiment”, “in another embodiment”, “in an exemplary embodiment”, “in an alternate embodiment”, “in one implementation”, “in another implementation”, “in an exemplary implementation”, and “in an alternate implementation” in various places in the specification are not necessarily all referring to the same embodiment or implementation, nor are separate or alternative embodiments/implementations mutually exclusive of other embodiments/implementations. Yet furthermore, the order of process flow representing one or more embodiments or implementations of the demonstration re-performing technique does not inherently indicate any particular order not imply any limitations of the demonstration re-performing technique.

The term “presenter” is used herein to refer to one or more people who are using a computer (herein also referred to as a computing device) to give a live presentation that includes the performance of a demonstration. Generally speaking and as is appreciated in the art of computers, a screencast (also known as a video screen capture) is a digital recording of what is displayed on the display screen of a computer display device (hereafter simply referred to as the display screen of a computer) over time. A screencast can optionally include audio content such as a narration, or the like. Accordingly, the term “screencast video” is used herein to refer to a video recording that captures what is displayed within a prescribed region of the display screen of a computer over time. A screencast video thus records the pixels within this prescribed region over time.

The term “visualization” is used herein to refer to either a graphical digital object, or a textual digital object, or a combination thereof that is overlaid on top of a video which is being played back on the display screen of a computer and can be quickly perceived and interpreted by a presenter. As will be described in more detail hereafter, in the demonstration re-performing technique embodiments described herein various types of visualizations can be overlaid on top of a screencast video, where these visualizations are visible to just a presenter (e.g., the visualizations cannot be seen by an audience). The term “sector” is used herein to refer to a segmented region of the display screen of a computer in which a particular type of graphical user interface (GUI) and/or information (such as a screencast video, and one or more visualizations, among other things) can be displayed, or a particular type of action can performed by a presenter or another user, where the GUI/information/action are generally associated with a particular application program that is running on the computer. As is appreciated in the art of computer operating environments, a given display screen can include a plurality of different sectors which may be layered or overlapped one on top of another. A given display screen can also be touch-sensitive.

### 1.0 Re-Performing Demonstrations During Live Presentations

Generally speaking and as will be described in more detail hereafter, the demonstration re-performing technique embodiments described herein provide presenters with an alternative to performing and narrating a live demonstration during a live presentation. More particularly, the demonstration re-performing technique embodiments allow a presenter to re-perform a demonstration during a live presentation by playing back a screencast video of the demonstration to an audience in a controlled manner and giving a live narration of the video as it is being played back. The demonstration re-performing technique embodiments also allow the presenter to rehearse their presentation (e.g., their live narration) of the video as it is being played back, and quickly edit the playback of the video based on their rehearsal experiences.

The demonstration re-performing technique embodiments described herein generate two different versions of the screencast video during its playback, namely an augmented version and an audience version. In an exemplary embodiment of the demonstration re-performing technique the augmented version of the screencast video is played back to just the presenter (it cannot be seen by the audience) and the audience version of the screencast video is played back to the audience. The augmented version includes various types of information that is automatically timed to the screencast video on-the-fly as it is being played back. This information includes various types of visualizations that are overlaid on top of the video on-the-fly as it is being played back, and an event timeline that is displayed adjacent to the video, among other things. In one embodiment of the demonstration re-performing technique the audience version is a non-augmented version of the screencast video (e.g., the audience version does not include any of the just-described information that is included in the augmented version). In another embodiment of the demonstration re-performing technique the audience version includes a user-configurable subset of this information. In yet another embodiment of the demonstration re-performing technique the audience version is the same as the augmented version.

As will be appreciated from the more detailed description that follows, the just-described visualizations and event timeline generally serve as visual cues that make the presenter who is playing back and narrating the screencast video aware of various aspects of the upcoming content and events in the demonstration that is recorded in the video. More particularly and by way of example but not limitation, the event timeline that is displayed adjacent to the video makes the presenter aware of the different topics that are covered in the demonstration, the sequence and timing of these different topics, and the sequence and timing of user input events and the results thereof that take place during each of the topics, among other things. The presenter can use the event timeline to navigate the video playback in various ways such as jumping to a specific topic in the video, or jumping to a specific event in the video, or jumping to a specific point in time in the video. The visualizations that are overlaid on top of the video make the presenter aware of when upcoming user input events will happen and where on the screen they will happen. The visualizations can also remind the presenter of one or more talking points that are to be spoken as the video is being played back, and when to speak each of the talking points.

The visualizations and event timeline are advantageous for various reasons including, but not limited to, the following. Generally speaking and as will be appreciated from the more detailed description that follows, the visualizations and event timeline provide the presenter with on-the-fly information assistance that enables them to anticipate, rather than react to, the content, the user input events, and the results thereof that are coming up in the screencast video as it is being played back. The visualizations and event timeline thus help the presenter guide the audience's attention to the right place at the right time. The visualizations and event timeline are also glanceable (e.g., the presenter can quickly perceive and interpret each of the visualizations and the event timeline at a glance with a minimal amount of attention).

The demonstration re-performing technique embodiments described herein are advantageous for various reasons including, but not limited to, the following. Generally speaking and as will be appreciated from the more detailed description that follows, the demonstration re-performing technique embodiments support the entire demonstration authoring process including, but not limited to, preparing a given demonstration, rehearsing and fine tuning (e.g., editing) the demonstration, and giving the demonstration during a live presentation. The demonstration re-performing technique embodiments also minimize the cognitive load and stress on presenters and allow them to give more effective, more understandable, and more engaging demonstrations in a natural, at ease, and time-efficient manner. As such, the demonstration re-performing technique embodiments enhance a presenter's experience in giving a live presentation that includes the performance and live narration of a demonstration. The demonstration re-performing technique embodiments also maximize the audience's attention to and level of engagement with the demonstration.

More particularly and by way of example but not limitation, the demonstration re-performing technique embodiments described herein eliminate the aforementioned issues that can occur during a live demonstration. The demonstration re-performing technique embodiments also allow a presenter to show an audience just the most significant parts of the demonstration in the lowest risk, most understandable, and most time-efficient manner. The demonstration re-performing technique embodiments also minimize the need for a presenter to have to remember the aforementioned various aspects of the demonstration. Accordingly, the demonstration re-performing technique embodiments make the presenter seem more at ease and in control while they are playing back and narrating the screencast video of the demonstration during the live presentation, thus further enhancing the effectiveness of the demonstration. The demonstration re-performing technique embodiments also help the presenter optimally guide the audience through the video as it is being played back. The demonstration re-performing technique embodiments also help the presenter precisely match the content and timing of their live narration to the video as it is being played back.

### 1.1 Workflow Framework

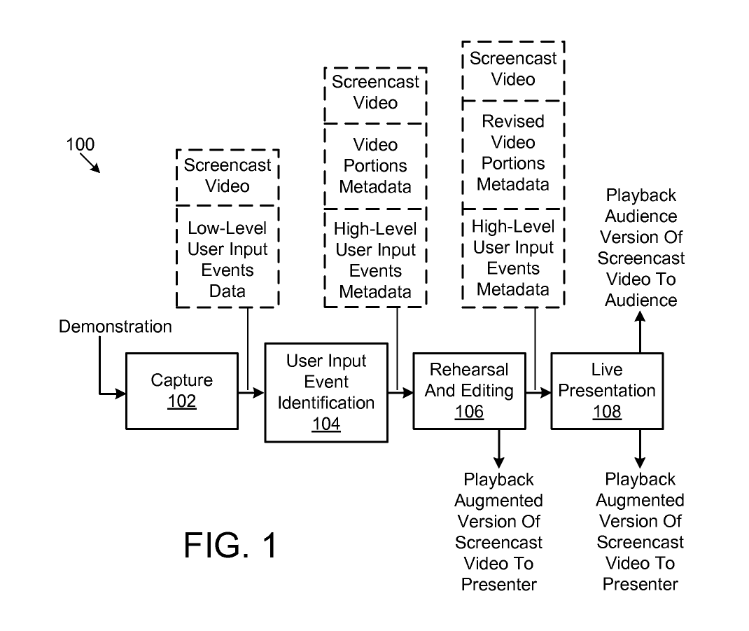

FIG. 1 illustrates an exemplary embodiment, in simplified form, of a lightweight workflow for allowing a presenter to re-perform a demonstration during a live presentation. As exemplified in FIG. 1, the workflow 100 includes four different phases, namely a capture phase 102, a user input event identification phase 104, a rehearsal and editing phase 106, and a live presentation phase 108. These four different phases 102/104/106/108 of the workflow 100 will now be described in more detail.

### 1.1.1 Capture Phase of the Workflow

Referring again to FIG. 1, during the capture phase 102 of the workflow 100 the demonstration is captured as it is being performed by a user on the display screen of a computer, where a sequence of low-level user input events (e.g., a sequence of user inputs to the computer) take place during the demonstration via a conventional mouse and a conventional physical keyboard. It is noted that the user who is performing the demonstration during the capture phase 102 may or may not be the presenter who will be re-performing the demonstration during the live presentation phase 108 of the workflow 100. In an exemplary embodiment of the demonstration re-performing technique described herein the demonstration is captured 102 in the following manner. A screencast video of the demonstration (herein sometimes simply referred to as a screencast video) is recorded as it is being performed by the user, and the screencast video is stored. The screencast video is recorded from a prescribed region of the display screen. In one implementation of this embodiment the prescribed region can be the entire display screen. In another implementation of this embodiment the prescribed region can be a user-specified portion of the display screen. In addition to recording and storing the screencast video, data which is associated with the sequence of low-level user input events that take place during the demonstration is stored. This data will be described in more detail hereafter.

As is appreciated in the art of software applications, in the case where the demonstration that is being performed is a software application demonstration, various types of low-level user input events can take place during the demonstration including, but are not limited to, the following. A mouse-button-down event is herein defined to take place whenever the user manually depresses a given button on the mouse. A mouse-button-up event is herein defined to take place whenever the user releases this button. A mouse-wheel-down event is herein defined to take place whenever the user rotates a scroll wheel on the mouse downward. A mouse-wheel-up event is herein defined to take place whenever the user rotates the scroll wheel upward. A key-press event is herein defined to take place whenever the user manually depresses a given key on the keyboard.

Various types of data are stored for each of the low-level user input events that take place during the demonstration, examples of which include, but are not limited to, the following. A time-stamp identifying when the low-level user input event takes place in the demonstration is stored. An event-type identifying the type of low-level user input event that takes place is also stored. The screen location (e.g., the x-y coordinates on the screen) where the low-level user input event takes place is also stored. In an exemplary embodiment of the demonstration re-performing technique described herein the time-stamp for the low-level user input event is obtained from the operating system of the computer and has an accuracy of 0.1 seconds. It is noted that alternate embodiments of the demonstration re-performing technique are also possible where the time-stamp can be obtained from a source other than the operating system of the computer, and can have an accuracy that is either greater than 0.1 seconds or less than 0.1 seconds.

Referring again to FIG. 1, it will be appreciated that during the capture phase 102 the demonstration can be performed a controlled (e.g., non-live) setting. This is advantageous for various reasons including, but not limited to, the following. The different parts of the demonstration can be performed and captured individually. If something goes wrong in one or more parts of the demonstration, these parts of the demonstration can be performed and captured again, thus eliminating many of the aforementioned issues that can occur during a live demonstration. Similarly, upon reviewing the recorded screencast video, it may be decided that one or more parts of the demonstration have to be modified in order to make them more effective and/or engaging. These parts of the demonstration can be modified as desired, and can then be performed and captured again.

### 1.1.2 User Input Event Identification Phase of the Workflow

Referring again to FIG. 1, during the user input event identification phase 104 of the workflow 100 the data that is associated with the sequence of low-level user input events is analyzed, and the sequence of low-level user input events is converted into a sequence of high-level user input events, where this conversion includes storing metadata for each of the high-level user input events. The metadata that is stored for a given high-level user input event includes, but is not limited to, the start-time of the high-level user input event (e.g., the specific point in time when the event starts), the end-time of the high-level user input event (e.g., the specific point in time when the event ends), the type of the high-level user input event, the screen location where the high-level user input event starts, and the screen location where the high-level user input event ends. In an exemplary embodiment of the demonstration re-performing technique described herein the sequence of low-level user input events are converted into a sequence of high-level user input events in the following manner.

A mouse-button-down mouse-button-up event sequence that takes place at substantially the same screen location is converted into a single-click event. As is appreciated in the art of computer user interface design, the user can perform a single-click event to select a particular item (such as either a file, or a menu item, or a toolbar icon, or a text field, or a checkbox, or a graphical button, or the like) that is displayed at a specific screen location. The start-time of the single-click event is the time-stamp of the mouse-button-down event in this sequence. The end-time of the single-click event is the time-stamp of the mouse-button-up event in this sequence.

A mouse-button-down mouse-button-up mouse-button-down mouse-button-up event sequence that takes place at substantially the same screen location within a prescribed double-click period of time is converted into a double-click event. It will be appreciated that this double-click period of time can have various values. By way of example but not limitation, the double-click period of time can be set to either a user-prescribed value or a default value that is employed in the computer on which the demonstration is captured. As is also appreciated in the art of computer user interface design, the user can perform a double-click event to open a particular file that is displayed at a specific screen location. The start-time of the double-click event is the time-stamp of the first mouse-button-down event in this sequence. The end-time of the double-click event is the time-stamp of the last mouse-button-up event in this sequence.

A mouse-button-down mouse-button-up event sequence that takes place at two different screen locations is converted into a drag event. As is also appreciated in the art of computer user interface design, the user can perform a drag event to move a selected item that is displayed on the display screen. The start-time of the drag event is the time-stamp of the mouse-button-down event in this sequence. The start-location of the drag event is the screen location where the mouse-button-down event takes place. The end-time of the drag event is the time-stamp of the mouse-button-up event in this sequence. The end-location of the drag event is the screen location where the mouse-button-up event takes place.

One or more consecutive mouse-wheel-down events that take place within a prescribed scrolling period of time is converted into a scroll-down event. The start-time of the scroll-down event is the time-stamp of the first of these mouse-wheel-down events. The end-time of the scroll-down event is the time-stamp of the last of these mouse-wheel-down events. One or more consecutive mouse-wheel-up events that take place within the scrolling period of time is converted into a scroll-up event. The start-time of the scroll-up event is the time-stamp of the first of these mouse-wheel-up events. The end-time of the scroll-up event is the time-stamp of the last of these mouse-wheel-up events. As is also appreciated in the art of computer user interface design, the user can perform a scroll-down/up event within a given sector on the display screen to scroll down/up the information that is displayed within the sector.

One or more consecutive key-press events that take place within a prescribed text-entry period of time is converted into a keystroke event. As is also appreciated in the art of computer user interface design, the user can perform a keystroke event to enter any character string (such as either a word, or a word phrase, or a number, or a word-number combination, or the like) into the computer. The start-time of the keystroke event is the time-stamp of the first of these key-press events. The end-time of the keystroke event is the time-stamp of the last of these key-press events. In an exemplary embodiment of the demonstration re-performing technique described herein the scrolling period of time is two seconds, and the text-entry period of time is equal to the scrolling period of time. It is noted that alternate embodiments are also possible where the scrolling period of time is either greater than two seconds or less than two seconds, and where the text-entry period of time is either greater than the scrolling period of time or less than the scrolling period of time.

After the sequence of low-level user input events has been analyzed and converted into a sequence of high-level user input events as just described, the sequence of high-level user input events is used to identify portions of the screencast video as either event portions or inactive portions, where this identification includes storing metadata for each of the portions of the screencast video. More particularly, each of the high-level user input events is mapped to a different event portion. Whenever a gap in time exists between two consecutive high-level user input events (e.g., whenever the end-time of a particular high-level user input event is not the same as the start-time of the high-level user input event that immediately succeeds the particular high-level user input event), this gap in time is mapped to an inactive portion. Examples of such a gap in time can include, but are not limited to, a period of time during which the user is simply moving the mouse, or another period of time during which a user interface transition is taking place, or yet another period of time during which the same video frame is repeated in the screencast video (e.g., there are no visible changes in the video).

In an exemplary embodiment of the demonstration re-performing technique described herein the metadata that is stored for a given portion of the screencast video includes, but is not limited to, the duration of the portion and an indicator specifying whether the portion is an event portion or an inactive portion. In the case where the portion is an event portion, the metadata that is stored for the portion also includes another indicator specifying the particular high-level user input event that is mapped to the portion. In the case where the portion is an event portion, the duration of the portion is initially computed to be the end-time of the high-level user input event that is mapped to the portion minus the start-time of this high-level user input event. In the case where the portion is an inactive portion, the duration of the portion is initially computed to be the duration of the gap in time that is mapped to the portion.

After portions of the screencast video have been identified as either event portions or inactive portions as just-described, the duration of each of the event portions of the screencast video can optionally be adjusted as necessary in order to ensure that the event portion can be easily observed by the audience. In an exemplary embodiment of the demonstration re-performing technique described herein this adjustment is performed in the following manner. Whenever the duration of the event portion is less than a prescribed minimum duration, the following actions will occur. Whenever an inactive portion immediately precedes the event portion the duration of the event portion is expanded by subtracting a prescribed amount of time from the start-time of the event portion (thus shorting the duration of the immediately preceding inactive portion by the prescribed amount of time). Whenever an inactive portion also immediately succeeds the event portion, the duration of the event portion is further expanded by adding the prescribed amount of time to the end-time of the event portion (thus shorting the duration of the immediately succeeding inactive portion by the prescribed amount of time). It will be appreciated that this expansion of the duration of the event portion results in the playback speed of the event portion being appropriately decreased, thus slowing down the event portion so that it can be easily observed by the audience. Whenever the duration of the shortened immediately preceding inactive portion is less than the prescribed minimum duration, the shortened immediately preceding inactive portion is merged into the expanded event portion. Similarly, whenever the duration of the shortened immediately succeeding inactive portion is less than the prescribed minimum duration, the shortened immediately succeeding inactive portion is also merged into the expanded event portion. In an exemplary embodiment of the demonstration re-performing technique described herein the prescribed minimum duration is one second and the prescribed amount of time is half a second. It is noted that other embodiments are also possible where the prescribed minimum duration is either greater than one second or less than one second, and where the prescribed amount of time is either greater than half a second or less than half a second.

### 1.1.3 Rehearsal and Editing Phase of the Workflow

Referring again to FIG. 1, during the rehearsal and editing phase 106 of the workflow 100 the presenter is provided with a video playback GUI that the presenter (or another user) can use to playback the screencast video, and rehearse their presentation (e.g., their live narration) of the screencast video as it is being played back. The presenter can also use the video playback GUI to quickly edit the playback of the screencast video based on their experiences while rehearsing their presentation of the screencast video. Generally speaking and as will be described in more detail hereafter, whenever the presenter requests to playback the screencast video, the demonstration re-performing technique embodiments described herein use the metadata that is stored for each of the high-level user input events, and the metadata that is stored for each of the portions of the video, to generate the aforementioned augmented version of the screencast video. The augmented version of the screencast video is generated on-the-fly as the screencast video is being played back. The presenter can edit the playback of the screencast video in various ways that can modify the content and the timing of the video as it is being played back.

As stated heretofore, the augmented version of the screencast video includes various types of information that is automatically timed to the video as it is being played back and provides the presenter with visual cues that make the presenter aware of various aspects of the upcoming content and events in the video. More particularly and as will be described in more detail hereafter, the augmented version of the screencast video includes an event timeline that is displayed adjacent to the video. Generally speaking, the augmented version of the screencast video also includes a visualization (e.g., a visible representation) of each of the high-level user input events that is automatically overlaid on top of the screencast video as the high-level user input event takes place and at the particular screen location where it takes place. The augmented version of the screencast video also includes a visualization of any text notes that the presenter inserts into the video while they are rehearsing it. The visualizations of both the high-level user input events and the text notes have a prescribed degree of transparency so that the presenter is able to see any video content that exists underneath the visualizations. It will be appreciated that this degree of transparency can have various values. In an exemplary embodiment of the demonstration re-performing technique described herein the degree of transparency is user configurable, which is advantageous since this transparency can be adapted to the particular characteristics of the screencast video.

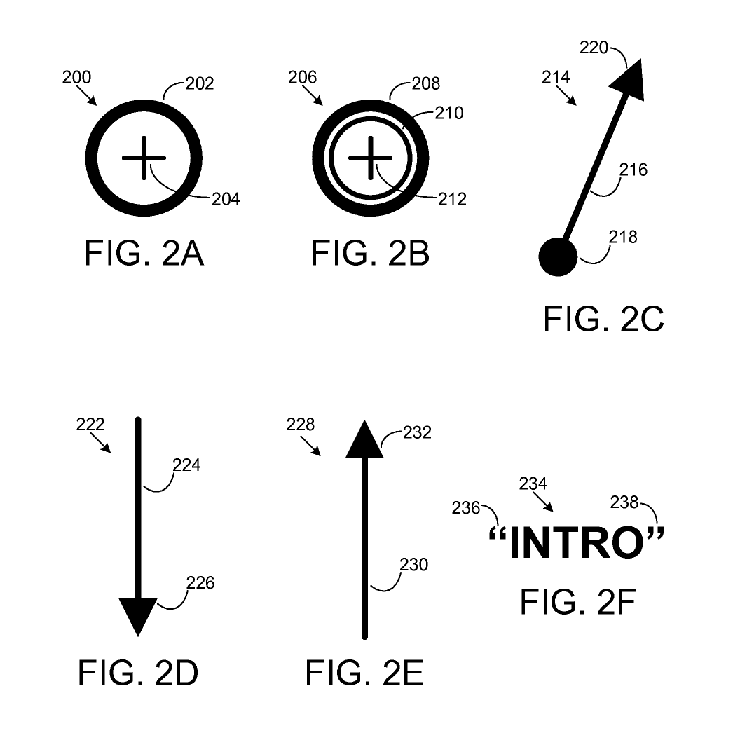

In an exemplary embodiment of the demonstration re-performing technique described herein the visualization of a given high-level user input event is a simple but distinct glyph that uniquely represents the event and can be accurately interpreted by the presenter even if the screencast video is visually complex. FIGS. 2A-2F illustrate exemplary embodiments, in simplified form, of the different glyphs that can be used to represent the aforementioned different types of high-level user input events.

FIG. 2A illustrates an exemplary embodiment, in simplified form, of a single-click glyph 200 that can be used to represent a single-click event. As exemplified in FIG. 2A, the single-click glyph 200 includes a circle 202 and a plus symbol 204 that is centered within the circle 202. The intersection point of the plus symbol 204 is overlaid on top of the screencast video at the screen location where the single-click event takes place. The single-click glyph 200 has a prescribed single-click color and the circle 202 has a prescribed radius (e.g., 20 pixels, among other possible radii).

FIG. 2B illustrates an exemplary embodiment, in simplified form, of a double-click glyph 206 that can be used to represent a double-click event. As exemplified in FIG. 2B, the double-click glyph 206 includes an outer circle 208, an inner circle 210 that is centered within the outer circle 208, and a plus symbol 212 that is centered within the inner circle 210. The intersection point of the plus symbol 212 is overlaid on top of the screencast video at the screen location where the double-click event takes place. The double-click glyph 206 has a prescribed double-click color and the outer circle 208 has the prescribed radius. In the double-click glyph embodiment shown in FIG. 2B, the line thickness of the outer circle 208 is greater than the line thickness of the inner circle 210. An alternate embodiment of the double-click glyph (not shown) is also possible where the line thickness of the outer circle can be either the same as or less than the line thickness of the inner circle.

FIG. 2C illustrates an exemplary embodiment, in simplified form, of a drag glyph 214 that can be used to represent a drag event. As exemplified in FIG. 2C, the drag glyph 214 includes a dot 218 that serves as the starting-point of the drag glyph, an arrowhead 220 that serves as the terminus of the drag glyph, and a line 216 that interconnects the dot 218 and arrowhead 220. The starting-point of the drag glyph 214 (e.g., the center of the dot 218) is overlaid on top of the screencast video at the start-location of the drag event. The terminus of the drag glyph 214 (e.g., the tip of the arrowhead 220) is overlaid on top of the screencast video at the end-location of the drag event. Accordingly, the length of the drag glyph 214 indicates the distance between the start-location and end-location of the drag event. The drag glyph 214 has a prescribed drag color.

FIG. 2D illustrates an exemplary embodiment, in simplified form, of a scroll-down glyph 222 that can be used to represent a scroll-down event. As exemplified in FIG. 2D, the scroll-down glyph 222 includes a line 224 having a prescribed length and an arrowhead 226 that is located at one end of the line 224. The scroll-down glyph 222 is centrally overlaid on top of the screencast video within the sector whose information is being scrolled down. FIG. 2E illustrates an exemplary embodiment, in simplified form, of a scroll-up glyph 228 that can be used to represent a scroll-up event. As exemplified in FIG. 2E, the scroll-up glyph 228 includes a line 230 having the prescribed length and an arrowhead 232 that is located at one end of the line 230. The scroll-up glyph 228 is centrally overlaid on top of the screencast video within the sector whose information is being scrolled up. In an exemplary embodiment of the demonstration re-performing technique described herein both the scroll-down glyph 222 and the scroll-up glyph 228 have a prescribed scroll color, and the prescribed length is 80 pixels. It is noted that alternate embodiments of the demonstration re-performing technique are also possible where the scroll-down glyph 222 and the scroll-up glyph 228 have different colors, and the prescribed length is either less than or greater than 80 pixels.

FIG. 2F illustrates an exemplary embodiment, in simplified form, of a keystroke glyph 234 that can be used to represent a keystroke event. As exemplified in FIG. 2F, the keystroke glyph 234 includes an opening quotation mark 236, followed by each of the key-press events that make up the keystroke event (INTRO in the exemplified case), followed by a closing quotation mark 238. The keystroke glyph 234 has a prescribed keystroke color. The keystroke glyph 234 is overlaid on top of the screencast video at the screen location where the keystroke event takes place.

Generally speaking, the different glyphs 200, 206, 220, 222, 228 and 234 exemplified in FIGS. 2A-2F can be any color and can have various different line thicknesses. More particularly and by way of example but not limitation, in one embodiment of the demonstration re-performing technique described herein each of the different glyphs 200, 206, 220, 222, 228 and 234 can have a prescribed common color (e.g., red, among other possible colors). In another embodiment of the demonstration re-performing technique each of the different glyphs 200, 206, 220, 222, 228 and 234 can have a different color. In an exemplary implementation of this particular embodiment the single-click color can be red, the double-click color can be green, the drag color can be orange, the scroll color can be yellow, and the keystroke color can be blue.

At any point in time during the playback of the screencast video, the augmented version of the screencast video includes a visualization of a prescribed number of consecutive high-level user input events, namely the high-level user input event that is currently taking place (hereafter simply referred to as the current high-level user input event) and one or more high-level user input events that immediately succeed the current high-level user input event. In an exemplary embodiment of the demonstration re-performing technique described herein this prescribed number is two so that at any point in time during the playback of the screencast video, the augmented version of the screencast video includes a visualization of the current high-level user input event and a visualization of the high-level user input event that immediately succeeds the current high-level user input event (hereafter simply referred to as the next high-level user input event).

Generally speaking and referring again to FIG. 1, in order to help the presenter guide the audience's attention to the next high-level user input event during the live presentation phase 108 of the workflow 100, a motion-arrow glyph can be automatically overlaid on top of the screencast video between the visualization of the current high-level user input event and the visualization of the next high-level user input event. As will be appreciated from the more detailed description of exemplary embodiments of the motion-arrow glyph that follows, a starting-point of the motion-arrow glyph is placed either at or near the screen location where the current high-level user input event ends, and a terminus of the motion-arrow glyph is placed either at or near the screen location where the next high-level user input event starts. Accordingly, the motion-arrow glyph shows the presenter the movement from the current high-level user input event (e.g., the single-clicking of a checkbox in order to check or un-check the checkbox) to the next high-level user input event (e.g., the single-clicking of a graphical button in order to select the button). The motion-arrow glyph thus leads the presenter's attention from one high-level user input event to the next, which is advantageous since it results in a visualization of the high-level user input events that matches the flow of the presenter's attention when they observe the playback of the screencast video.

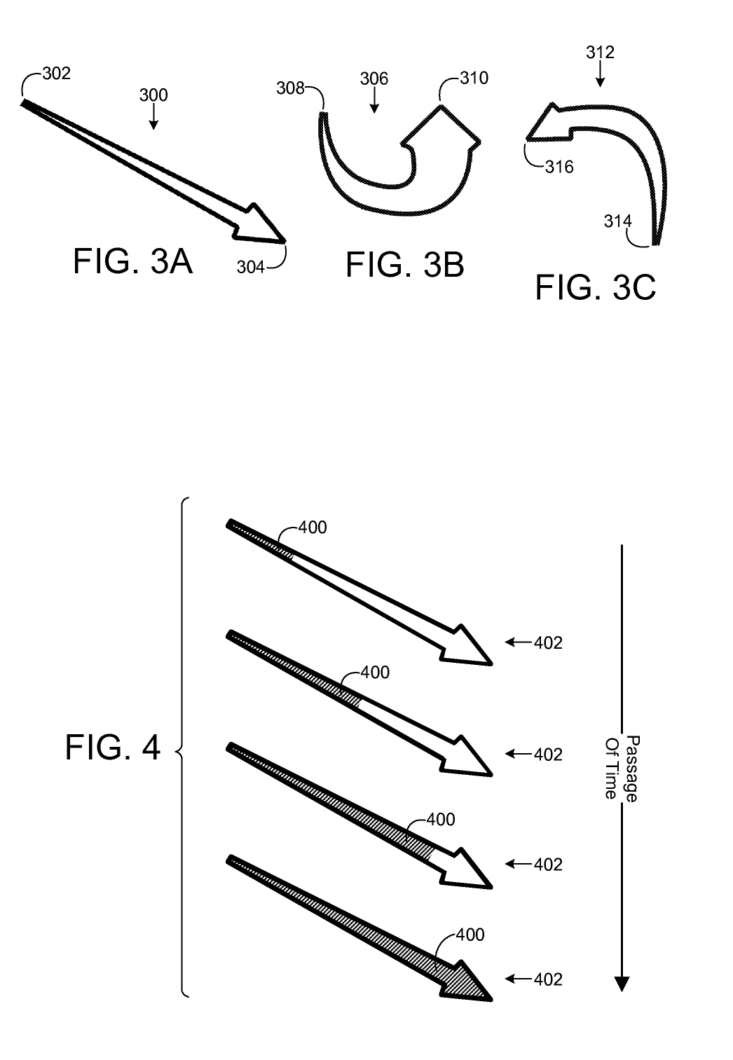

Since the distance between two consecutive high-level user input events can vary, the demonstration re-performing technique embodiments described herein employ three different types of motion-arrow glyphs in order to ensure that a given motion-arrow glyph will always be visible to the presenter. FIGS. 3A-3C illustrate exemplary embodiments, in simplified form, of these three different types of motion-arrow glyphs.

FIG. 3A illustrates an exemplary embodiment, in simplified form, of a straight motion-arrow glyph that is overlaid on top of the screencast video between the visualization of the current high-level user input event and the visualization of the next high-level user input event whenever the screen location where the current high-level user input event ends is greater than or equal to a prescribed long distance away from the screen location where the next high-level user input event starts. As exemplified in FIG. 3A, the straight motion-arrow glyph 300 includes a starting-point 302 that is placed at the screen location where the current high-level user input event ends, and a terminus 304 that is placed at the screen location where the next high-level user input event starts. Accordingly, the straight motion-arrow glyph 300 is used in circumstances where the current and next high-level user input events are located far away from each other, such as when the single-clicking of a checkbox is immediately succeeded by the single-clicking of an “OK” button. It will be appreciated that the long distance can have various values. In an exemplary embodiment of the demonstration re-performing technique described herein the long distance is user-configurable.

FIG. 3B illustrates an exemplary embodiment, in simplified form, of a round motion-arrow glyph that is overlaid on top of the screencast video between the visualization of the current high-level user input event and the visualization of the next high-level user input event whenever the screen location where the current high-level user input event ends is less than or equal to a prescribed short distance away from the screen location where the next high-level user input event starts, where this short distance is significantly less than the long distance. As exemplified in FIG. 3B, the round motion-arrow glyph 306 includes a starting-point 308 that is placed either at or near the screen location where the current high-level user input event ends, and a terminus 310 that is placed either at or near the screen location where the next high-level user input event starts. Accordingly, the round-motion arrow glyph 306 is used in circumstances where the current and next high-level user input events are located close to each other, such as when the single-clicking of a “NEXT” button is immediately succeeded by another single-clicking of the “NEXT” button (which can occur when a list of selections is being navigated, among other possible circumstances). It will be appreciated that the short distance can have various values. In an exemplary embodiment of the demonstration re-performing technique described herein the short distance is user-configurable.

FIG. 3C illustrates an exemplary embodiment, in simplified form, of a curved motion-arrow glyph that is overlaid on top of the screencast video between the visualization of the current high-level user input event and the visualization of the next high-level user input event whenever the screen location where the current high-level user input event ends is less than the long distance and greater than the short distance away from the screen location where the next high-level user input event starts. As exemplified in FIG. 3C, the curved motion-arrow glyph 312 includes a starting-point 314 that is placed at the screen location where the current high-level user input event ends, and a terminus 316 that is placed at the screen location where the next high-level user input event starts.

Generally speaking, various methods can be optionally employed to provide the presenter with a sense of timing for the next high-level user input event, and thus enable the presenter to optimally time their narration of the screencast video playback. By way of example but not limitation, in one embodiment of the demonstration re-performing technique described herein a progress bar can be embedded within each of the just-described different types of motion-arrow glyphs. In another embodiment of the demonstration re-performing technique each of the aforementioned different glyphs that represent the different types of high-level user input events can be implemented using a countdown version of the glyph that visually coveys the specific timing of when an impending high-level user input event will start. These progress bar and countdown version embodiments will now be described in more detail.

FIG. 4 illustrates an exemplary alternate embodiment, in simplified form, of the aforementioned straight motion-arrow glyph that includes a progress bar embedded there-within. As exemplified in FIG. 4, the length of the progress bar 400 within the straight motion-arrow glyph 402 increases incrementally with the passage of time, thus giving the presenter a relative sense of the passage of time. More particularly, the progress bar 400 visually indicates to the presenter the proportional amount of time that remains until the next high-level user input event starts. When the progress bar 400 completely fills the straight motion-arrow glyph 402 the glyph 402 will fade out and the next high-level user input event will become the current high-level user input event. It is noted that alternate embodiments of the round and curved motion-arrow glyphs (not shown) are also possible that include a progress bar similarly embedded there-within.

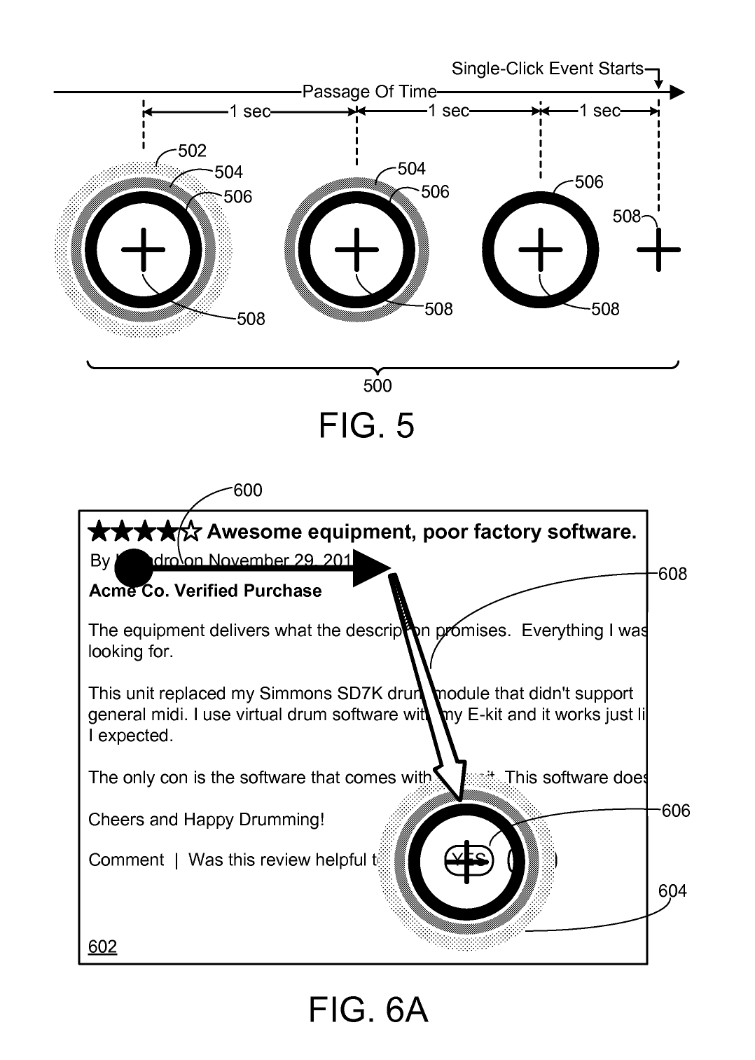

FIG. 5 illustrates an exemplary embodiment, in simplified form, of a countdown version of the aforementioned single-click glyph. Generally speaking and as exemplified in FIG. 5, the countdown version of the single-click glyph 500 changes incrementally with the passage of time in a manner that visually coveys the specific timing of when an impending single-click event that is represented by the glyph 500 will start. More particularly, the glyph 500 that is initially overlaid on top of the screencast video includes three concentric circles, namely an outermost circle 502, a middle circle 504, and an innermost circle 506. The glyph 500 also includes a plus symbol 508 that is centered within the three concentric circles 502/504/506. The intersection point of the plus symbol 508 is overlaid on top of the screencast video at the screen location where the impending single-click event will take place. Two seconds before the single-click event starts the outermost circle 502 will be removed from the glyph 500. One second before the single-click event starts the middle circle 504 will be removed from the glyph 500. At the specific time that the single-click event starts the innermost circle 506 will be removed from the glyph 500. These timed incremental changes in the glyph 500 thus provide the presenter with a countdown visualization of the amount of time remaining before the single-click event starts.

It will be appreciated that alternate embodiments (not shown) of the countdown version of the single-click glyph are also possible where the interval of time between successive changes in the glyph is either less than one second or greater than one second, and where the number of concentric circles is either less than three or greater than three. It will also be appreciated that similar countdown versions of the aforementioned double-click glyph, drag glyph, scroll-down glyph, scroll-up glyph, and keystroke glyph are possible.

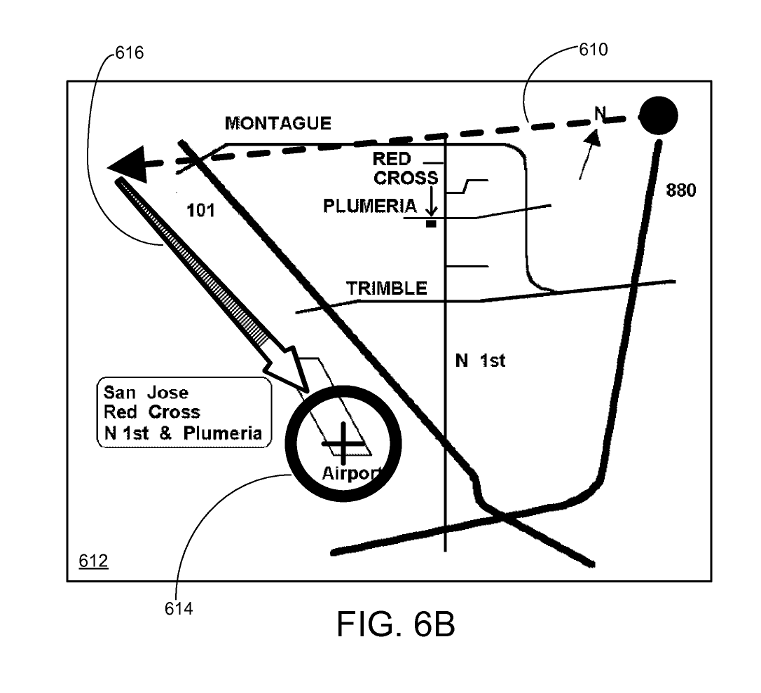

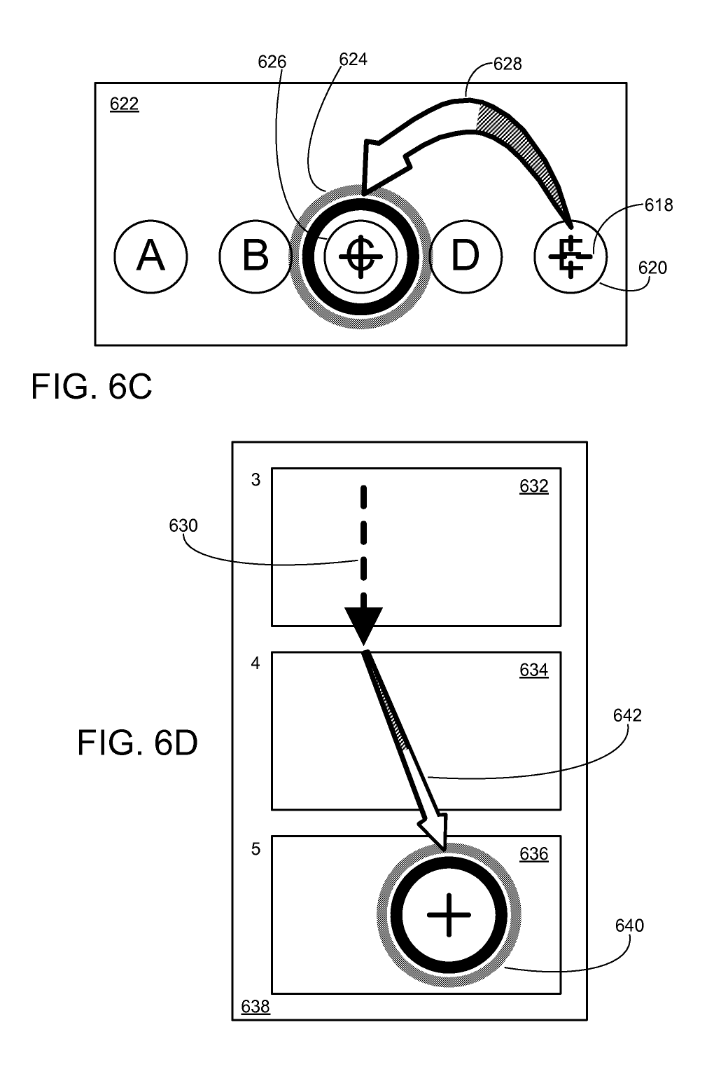

FIG. 6A illustrates an exemplary embodiment, in simplified form, of the visualization of a current drag event that is immediately succeeded by a single-click event. The drag glyph 600 exemplified in FIG. 6A conveys to the presenter that a customer review of a product which is displayed within a sector 602 has just been dragged to the right. The countdown version of the single-click glyph 604 exemplified in FIG. 6A conveys to the presenter that the next high-level user input event in the screencast video will be the single-clicking of a “YES” button 606 which is displayed within the sector 602. The fact that the countdown version of the single-click glyph 604 has all three of its concentric circles conveys to the presenter that the impending single-clicking of the “YES” button 606 is currently more than three seconds from taking place. The straight motion-arrow glyph 608 helps the presenter guide the audience's attention to this impending single-clicking of the “YES” button 606. The drag glyph 600 will fade out as the time until the single-clicking of the “YES” button 606 decreases.

FIG. 6B illustrates an exemplary embodiment, in simplified form, of the visualization of an impending single-click event that was immediately preceded by a drag event. The drag glyph 610 exemplified in FIG. 6B, which has just faded out, conveyed to the presenter that a street map which is displayed within a sector 612 has just been dragged to the left and slightly downward. The countdown version of the single-click glyph 614 exemplified in FIG. 6B conveys to the presenter that the next high-level user input event in the screencast video will be the single-clicking of an “Airport” which appears on the map. The fact that the countdown version of the single-click glyph 614 has just one of its concentric circles conveys to the presenter that the impending single-clicking of the “Airport” is currently one second or less from taking place. The straight motion-arrow glyph 616 helps the presenter guide the audience's attention to this impending single-clicking of the “Airport”.

FIG. 6C illustrates an exemplary embodiment, in simplified form, of the visualization of an impending single-click event that was immediately preceded by another single-click event. The countdown version of the single-click glyph 618 exemplified in FIG. 6C, which has just faded out, conveyed to the presenter that an “E” button 620 which is displayed within a sector 622 has just been single-clicked. The countdown version of the single-click glyph 624 exemplified in FIG. 6C conveys to the presenter that the next high-level user input event in the screencast video will be the single-clicking of a “C” button 626 which is also displayed within the sector 622. The fact that the countdown version of the single-click glyph 624 has just two of its concentric circles conveys to the presenter that the impending single-clicking of the “C” button 626 is currently between one and two seconds from taking place. The curved motion-arrow glyph 628 helps the presenter guide the audience's attention to this impending single-clicking of the “C” button 626.

FIG. 6D illustrates an exemplary embodiment, in simplified form, of the visualization of an impending single-click event that was immediately preceded by a scroll-down event. The scroll-down glyph 630 exemplified in FIG. 6D, which has just faded out, conveyed to the presenter that a series of slides 632/634/636 which is displayed within a sector 638 has just been scrolled down. The countdown version of the single-click glyph 640 exemplified in FIG. 6D conveys to the presenter that the next high-level user input event in the screencast video will be the single-clicking of the fifth slide 636 in the series of slides 632/634/636. The fact that the countdown version of the single-click glyph 640 has just two of its concentric circles conveys to the presenter that the impending single-clicking of the fifth slide 636 is currently between one and two seconds from taking place. The straight motion-arrow glyph 642 helps the presenter guide the audience's attention to this impending single-clicking of the fifth slide 636.

As will be appreciated from the more detailed description of the video playback GUI that is provided hereafter, the presenter can use the GUI to quickly edit the playback of the screencast video in various ways while they are rehearsing their live narration of the video, where this editing results in revisions being made to the metadata that is stored for one or more of the portions of the video. By way of example but not limitation, the presenter can use the GUI to input a request to group a specific sequence of portions of the screencast video into a topic, and to input a text label for the topic. Upon receiving this request and text label, the metadata for each of the portions in this specific sequence will be revised to indicate that the portion is part of the topic having the text label. The presenter can define the topics in any manner they desire. By way of example but not limitation, in the case where a software application is being demonstrated, a given sequence of portions of the screencast video may be associated with a particular high-level feature of the application.

Generally speaking, the presenter can also use the video playback GUI to modify the content and timing of the screencast video in various ways as it is being played back. This is advantageous since it allows the presenter to fine tune the playback of the screencast video to match the needs of a particular live presentation they will be giving (e.g., different presentations to different audiences may call for either more or less extensive narrations during certain parts of the video, the overall length of the video as it was originally recorded may exceed the amount of time the presenter has to give the presentation, and the presenter may determine that certain parts of the video progress either too slowly or too quickly). More particularly and by way of example but not limitation, the presenter can use the GUI to input a request to adjust (e.g., either increase or decrease) the playback speed of a specific portion of the screencast video. Upon receiving this request, the metadata for the specific portion will be revised to indicate that the specific portion is to be played back at this adjusted speed. An exemplary situation where the presenter may choose to increase the playback speed of a specific portion is where the portion is an event portion to which a keystroke event is mapped, and the presenter feels that the keystroke event progresses too slowly and thus may bore the audience. An exemplary situation where the presenter may choose to decrease the playback speed of a specific portion is where the portion is an event portion to which a drag event is mapped, and the presenter feels that the drag event progresses too quickly (e.g., the mouse was moved very quickly during the drag) and thus may not be understandable by the audience. The presenter may also choose to adjust the playback speed of a specific event portion in order to match the playback duration of the event portion to their narration thereof.

The presenter can also use the video playback GUI to input a request to insert a pause segment having a specified length of time into a specific portion of the screencast video. Upon receiving this request, the metadata for the specific portion will be revised to indicate that the specific portion includes this pause segment. The pause segment will cause the playback of the portion to automatically pause at the last frame thereof for the specified length of time, after which the playback of the screencast video will automatically resume. The presenter can also use the GUI to input a request to remove a previously inserted pause segment.

The presenter can also use the video playback GUI to input a request to insert a stop segment into a specific portion of the screencast video. Upon receiving this request, the metadata for the specific portion will be revised to indicate that the specific portion includes the stop segment. The stop segment will cause the playback of the portion to automatically stop at the last frame thereof. The playback of the screencast video will not resume until the presenter provides an explicit input to do so (such as the presenter pressing any key on the keyboard, or the presenter using the mouse to single-click a pause/play icon that is displayed in the GUI, among other types of input). The presenter can also use the GUI to input a request to remove a previously inserted stop segment.

The presenter can also use the video playback GUI to input a request to insert a text note into a specific portion of the screencast video, where the text note has been sized and positioned by the presenter at a desired screen location (e.g., the presenter can adjust the size of the text note and move the text note to a screen location that insures the text note won't block video content that the presenter feels the audience needs to see). Upon receiving this request, the metadata for the specific portion will be revised to indicate that the specific portion includes the text note, and that the text note is to be automatically overlaid on top of the screencast video at the desired screen location. During the playback of the screencast video a visualization of the text note will be automatically overlaid on top of the video a prescribed note display period of time before the portion starts, and the text note will be automatically removed from the display screen when the portion starts. In an exemplary embodiment of the demonstration re-performing technique described herein the prescribed note display period of time is three seconds. However, alternate embodiments of the demonstration re-performing technique are also possible where the prescribed note display period of time is either less than or greater than three seconds. This text note feature is advantageous for various reasons including, but not limited to, the following. Text notes can be used by the presenter to remind them of a particular talking point that is to be spoken, or a particular feature that will be shown, during the playback of the portion. The presenter can also use the GUI to input a request to remove a previously inserted text note.

The presenter can also use the video playback GUI to input a request to hide a specific portion of the screencast video. Upon receiving this request, the metadata for the specific portion will be revised to indicate that the specific portion is to be hidden during the playback of the screencast video. The hiding of a portion will cause the portion to be skipped during the playback of the screencast video, thus shortening the video playback time accordingly. The presenter can also use the video playback GUI to input a request to unhide a previously hidden portion.

The presenter can also use the video playback GUI to input a request to hide a specific topic in the screencast video. Upon receiving this request, the metadata for the sequence of portions of the screencast video that makes up the specific topic will be revised to indicate that this sequence of portions is to be hidden during the playback of the screencast video. The hiding of a topic will cause the entire topic (e.g., the entire sequence of portions that makes up the topic) to be skipped during the playback of the screencast video, thus shortening the video playback time accordingly. The presenter can also use the video playback GUI to input a request to unhide a previously hidden topic.

In an exemplary embodiment of the demonstration re-performing technique described herein the various types of edits that the presenter can make to the playback of the screencast video do not modify the screencast video itself. Rather, as just described, the edits revise the metadata that is stored for one or more of the portions of the video. Accordingly, the presenter can make one set of edits to the playback of the screencast video for one presentation, and can store one version of revised video portions metadata that includes this one set of edits. The presenter can then make another set of edits to the playback of the screencast video for another presentation, and can store another version of revised video portions metadata that includes this other set of edits.

### 1.1.4 Live Presentation Phase of the Workflow

Generally speaking and referring again to FIG. 1, during the live presentation phase 108 of the workflow 100 the presenter uses the same video playback GUI that they used during the rehearsal and editing phase 106 to re-perform the demonstration during a live presentation to an audience by playing back the screencast video in a controlled manner and giving a live narration of the video as it is being played back. More particularly, whenever the presenter requests to playback the screencast video, the demonstration re-performing technique embodiments described herein read the metadata that is stored for each of the high-level user input events, and a presenter-specified version of revised video portions metadata that was stored during the rehearsal and editing phase 106, and interpret this metadata on-the-fly as the video is being played back to determine how each of the portions of the video is to be played back (e.g., whether or not the portion is to be played back at an adjusted speed, whether or not the portion includes a pause segment or a stop segment, whether or not the portion includes a text note, and whether or not the portion is to be skipped during the playback of the video). This metadata also determines the content and structure of the event timeline that is included in the augmented version of the screencast video.

As described heretofore, in conjunction with the augmented version of the screencast video being played back to the presenter, an audience version of the screencast video is played back to the audience. This audience version is a full-screen video that is played back on a different display screen than the augmented version. The playback of the audience version is synchronized to the playback of the augmented version so that each of the portions of the audience version is played back synchronously with (e.g., at the same playback speed and with the same timing as) the corresponding portion of the augmented version. As also described heretofore, the audience version of the screencast video may be a non-augmented version of the screencast video (e.g., it may not include any of the aforementioned overlaid visualizations or the aforementioned event timeline that are included in the augmented version), or it may include a user-configurable subset of these augmentations, or it may be the same as the augmented version.

Generally speaking and as will be appreciated from the more detailed description of the video playback GUI that follows, the presenter can use the GUI to control the playback of the screencast video in various ways. By way of example but not limitation, the presenter can use the GUI to initiate the video playback, pause the video playback at any point in time, and resume the video playback at any subsequent point in time. Additionally, whenever the video playback is paused, the presenter can visually point out a specific region of the currently displayed video frame to the audience as follows. The presenter can use the mouse to hover a cursor over the specific region on the augmented version of the currently displayed video frame that the presenter sees in the GUI, and the demonstration re-performing technique embodiments described herein will then overlay another cursor onto the same region of the audience version of the currently displayed full-screen video frame that the audience sees, thus drawing the audience's attention to this region. The presenter's cursor and the cursor that the audience sees are synchronized so that the cursor that the audience sees will move synchronously with any movement of the presenter's cursor.

### 1.2 User Interface Framework

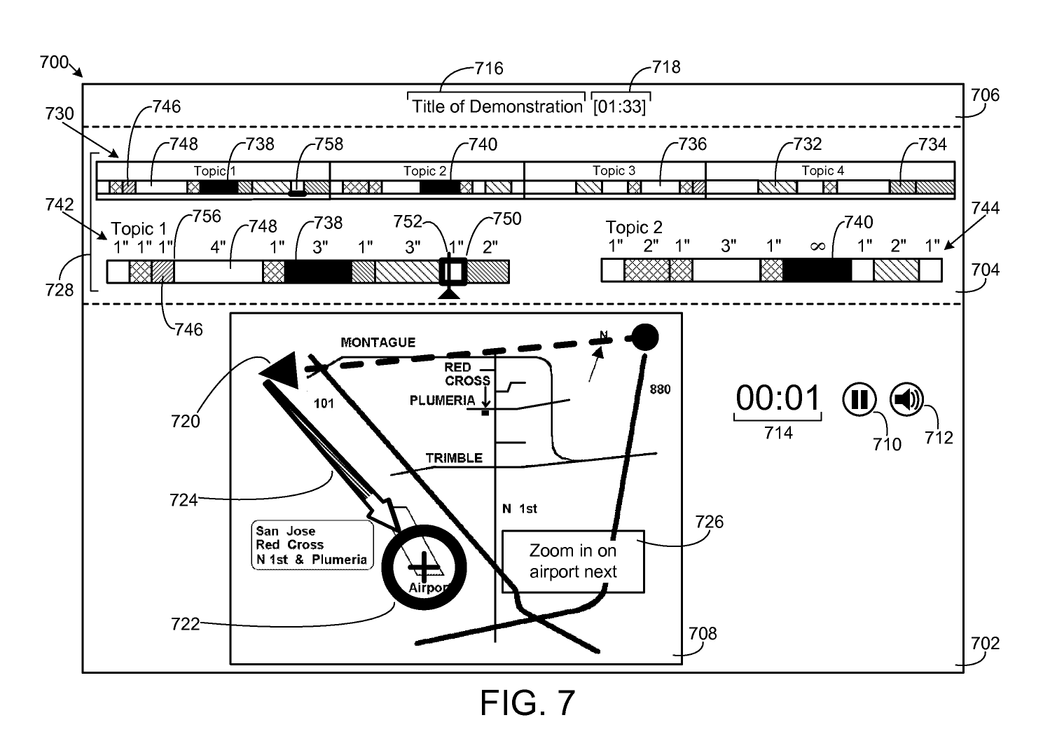

FIG. 7 illustrates an exemplary embodiment, in simplified form, of a generalized layout for the video playback GUI that allows the presenter to rehearse and edit the demonstration, and also to re-perform the demonstration during a live presentation to an audience. As will be appreciated from the more detailed description that follows, the video playback GUI 700 exemplified in FIG. 7 provides the presenter with an integrated, interactive tool that they can use to rehearse, edit and re-perform the demonstration in an intuitive, easy to use, and controlled manner. As exemplified in FIG. 7, the GUI 700 includes a video sector 702 and a timeline sector 704, and can optionally also include a title sector 706. Exemplary embodiments of the usage of these different sectors 702/704/706 will now be described in more detail.

Referring again to FIG. 7, upon receiving a request from the presenter to playback the screencast video of the demonstration, the augmented version of the screencast video 708 is played back within the video sector 702. The frame of the video 708 that is exemplified in FIG. 7 includes a drag glyph 720 (which has just faded out), the countdown version of a single-click glyph 722, a straight motion-arrow glyph 724, and a text note visualization 726 that are overlaid on top of a street map. Before it faded out, the drag glyph 720 conveyed to the presenter that the street map has just been dragged to the left and slightly downward. The single-click glyph 722 conveys to the presenter that the next high-level user input event in the video will be the single-clicking of an “Airport” which appears on the map. The fact that the single-click glyph 722 has just one of its concentric circles conveys to the presenter that the impending single-clicking of the “Airport” is currently one second or less from taking place. The straight motion-arrow glyph 724 helps the presenter guide the audience's attention to this impending single-clicking of the “Airport”. The text note visualization 726 reminds the presenter that the demonstration will next zoom in on the “Airport”.

Referring again to FIG. 7, a pause/play icon 710 is also displayed within the video sector 702. The presenter can pause the playback of the screencast video by selecting the pause/play icon 710. The presenter can subsequently resume the playback of the video by again selecting the pause/play icon 710. A mute icon 712 can optionally also be displayed within the video sector 702. The presenter can mute the playback of any audio content that is included in the video by selecting the mute icon 712. The presenter can subsequently resume the playback of this audio content by again selecting the mute icon 712. A time counter 714 can optionally also be displayed within the video sector 702. In an exemplary embodiment of the demonstration re-performing technique described herein the time counter 714 indicates the current video playback position and has a starting value of 00:00 (e.g., zero minutes and zero seconds) when the first frame of the video is played back.

Referring again to FIG. 7, an event timeline 728 is displayed within the timeline sector 704. As exemplified in FIG. 7, the event timeline 728 includes an overall timeline 730 that shows each of the event portions (e.g., 746/732/734), each of the inactive portions (e.g., 748 and 736), each of the pause segments (e.g., 738), and each of the stop segments (e.g., 740) in the screencast video. The event timeline 728 can optionally also include a current topic timeline 742 that shows an enlarged view of each of the portions/segments in the topic that is currently being played back (which is “Topic 1” in the illustrated case). The event timeline 728 can optionally also include a next topic timeline 744 that shows an enlarged view of each of the portions/segments in the topic that is next to be played back (which is “Topic 2” in the illustrated case). The presenter can use the event timeline 728 to navigate the video playback in various ways including, but not limited to, the following. The presenter can jump to a specific topic (e.g., “Topic 2”) in the video by selecting this topic in the overall timeline 730. The presenter can jump to a specific portion (e.g., 732) of the video by selecting this portion in the overall timeline 730. In the case where the presenter wants to jump to a specific portion that is part of the topic that is currently being played back, the presenter can also select this portion in the current topic timeline 742. In the case where the presenter wants to jump to a specific portion that is part of the topic that is next to be played back, the presenter can also select this portion in the next topic timeline 744.

As also exemplified in FIG. 7, the width of each of the event portions (e.g., 746/732/734) in the overall, current topic and next topic timelines 730/742/744 is adapted to visually indicate the playback duration of the event portion rounded to the nearest second. The width of each of the inactive portions (e.g., 748 and 736) in the overall, current topic and next topic timelines is also adapted to visually indicate the playback duration of the inactive portion rounded to the nearest second. The width of each of the pause segments (e.g., 738) in the overall, current topic and next topic timelines is also adapted to visually indicate the playback duration of the pause segment rounded to the nearest second. Each of the portions/segments in the current topic and next topic timelines 742 and 744 is labeled with the playback duration of the portion/segment rounded to the nearest second (e.g., event portion 746 has a playback duration of 1 second, inactive portion 748 has a playback duration of 4 seconds, and pause segment 738 has a playback duration of 3 seconds). Each of the stop segments (e.g., 740) in the current topic and next topic timelines 742 and 744 is labeled with an infinity symbol, thus differentiating the stop segment from the pause segment.

Generally speaking and referring again to FIG. 7, in an exemplary embodiment of the demonstration re-performing technique described herein each of the portions (e.g., 746) of the event timeline 728 can be color coded in order to visually indicate to the presenter the type of the portion, and in the case where the portion is an event portion, also visually indicate to the presenter the type of the high-level user input event that is mapped to the portion. More particularly, in an exemplary implementation of this embodiment a given portion of the event timeline can have the aforementioned single-click color whenever the portion is an event portion to which a single-click event is mapped. The portion can have the aforementioned double-click color whenever the portion is an event portion to which a double-click event is mapped. The portion can have the aforementioned drag color whenever the portion is an event portion to which a drag event is mapped. The portion can have the aforementioned scroll color whenever the portion is an event portion to which either a scroll-down event or a scroll-up event is mapped. The portion can have the aforementioned keystroke color whenever the portion is an event portion to which a keystroke event is mapped. The portion can have a prescribed inactive color (e.g., grey, among other possible colors that are different than the single-click, double-click, drag, scroll and keystroke colors) whenever the portion is an inactive portion. The portion can have a prescribed stop color (e.g., black, among other possible colors that are different than the single-click, double-click, drag, scroll, keystroke and inactive colors) whenever the portion is either a pause segment or a stop segment.

Referring again to FIG. 7, a demonstration title 716 is displayed within the optional title sector 706, where the demonstration title has been previously input by the presenter during the rehearsal and editing phase of the workflow, and is stored as metadata with the screencast video. The total playback time 718 of the screencast video can be appended to the demonstration title 716 as exemplified in FIG. 7. It is noted that each time the presenter edits the playback of the screencast video in a way that affects the timing of the video (e.g., each time the presenter either adjusts the playback speed of a portion of the video, or inserts a pause segment into the video, or removes a previously inserted pause segment, or hides a portion of the video, or unhides a previously hidden portion, or hides a topic in the video, or unhides a previously hidden topic), the demonstration re-performing technique embodiments described herein will automatically re-compute and update the total playback time 718 accordingly, and will also automatically update the event timeline 728 accordingly. By way of example but not limitation, in the case where the presenter increases (decreases) the playback speed of a given portion, the width of the portion in the event timeline will be appropriately decreased (increased), the playback duration label for the portion will be appropriately decreased (increased), and the total playback time will be appropriately decreased (increased). In the case where the presenter inserts (removes) a pause segment into the video, the pause segment will be added to (removed from) the event timeline, and the total playback time will be appropriately increased (decreased). In the case where the presenter hides (unhides) a portion of the video, the portion will be removed from (added back to) the event timeline, and the total playback time will be appropriately decreased (increased). Similarly, in the case where the presenter hides (unhides) a topic in the video, the topic will be removed from (added back to) the event timeline, and the total playback time will be appropriately decreased (increased).

Referring again to FIG. 7, in an exemplary embodiment of the demonstration re-performing technique described herein the presenter can adjust the playback speed of a desired portion (e.g., 746) in the event timeline 728 in the following manner. The presenter can decrease the playback speed of the desired portion by dragging the ending boundary (e.g., 756) of the desired portion to the right, thus increasing the width of the desired portion and increasing its playback duration. The presenter can increase the playback speed of the desired portion by dragging the ending boundary of the desired portion to the left, thus decreasing the width of the desired portion and decreasing its playback duration. The presenter can insert either a pause segment, or a stop segment, or a text note into a desired portion in the event timeline in the following manner. The presenter can use the mouse to right-click on the desired portion, after which a menu of editing choices (not shown) will be popped up in the video playback GUI 700. The presenter can then select either an “insert pause segment” item, or an “insert stop segment” item, or an “insert text note” item in this menu. The presenter can hide either a desired portion in the event timeline, or hide the entire topic that includes the desired portion, in the following manner. After using the mouse to right-click on the desired portion, the presenter can then select either a “hide portion” item or a “hide topic” item in the menu of editing choices that is popped up.

Referring again to FIG. 7, in order to enhance the presenter's ability to discern the sequence of high-level user input events that takes place during each of the topics in the event timeline 728, the event portions in the current topic timeline 742 can optionally be sequentially numbered (not shown), and the events portions in the next topic timeline 744 can also optionally be sequentially numbered (not shown). In order to enhance the presenter's ability to keep track of the current video playback position during the playback of the screencast video, the video playback GUI 700 can include the following playback position visual indicators that automatically move along the event timeline 728 as the video is being played back. The portion of the video that is currently being played back can be visually indicated by a horizontal bar 758 that is displayed along the bottom of this portion in the overall timeline 730. The portion of the video that is currently being played back can also be visually indicated by a box 750 that is displayed around this portion in the current topic timeline 742. The current playback point within the portion of the video that is currently being played back can be visually indicated by a vertical bar 752 that is displayed through this portion in the current topic timeline 742.

### 1.3 Process Framework

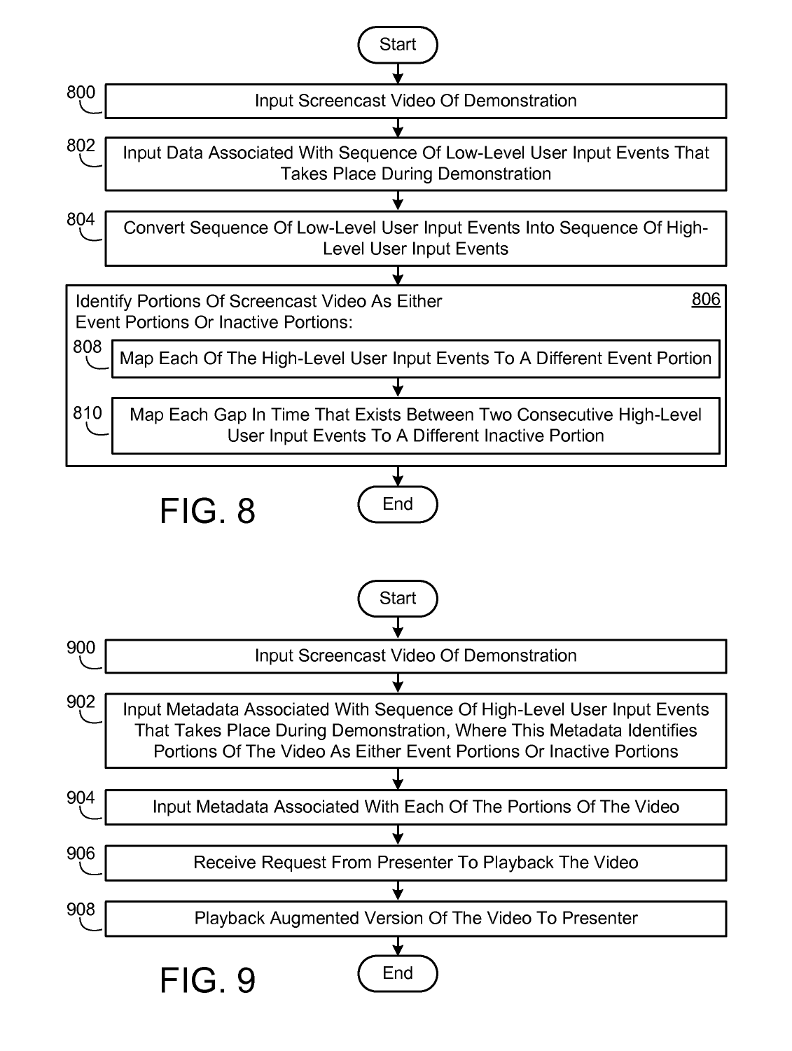

FIG. 8 illustrates an exemplary embodiment, in simplified form, of a process for identifying user input events in a screencast video of a demonstration. As exemplified in FIG. 8, the process starts in block 800 with inputting the screencast video. Data which is associated with the aforementioned sequence of low-level user input events that takes place during the demonstration is then input (block 802). The sequence of low-level user input events is then converted into a sequence of high-level user input events (block 804) as described heretofore. Portions of the screencast video are then identified as either event portions or inactive portions (block 806). As also described heretofore, this identification includes the actions of mapping each of the high-level user input events to a different event portion (block 808), and mapping each gap in time that exists between two consecutive high-level user input events to a different inactive portion (block 810).

FIG. 9 illustrates an exemplary embodiment, in simplified form, of a process for allowing a presenter to rehearse and edit a demonstration. As exemplified in FIG. 9, the process starts in block 900 with inputting a screencast video of the demonstration. Metadata which is associated with the sequence of high-level user input events that takes place during the demonstration is then input, where this metadata identifies portions of the screencast video as either event portions or inactive portions (block 902) as just described. Metadata which is associated with each of the portions of the screencast video is then input (block 904). Upon receiving a request from the presenter to playback the screencast video (block 906), an augmented version of the screencast video is played back to the presenter (block 908). As described heretofore, the augmented version of the screencast video that is played back to the presenter is generated on-the-fly as the screencast video is being played back. During at least one point in time during this playback, the augmented version of the screencast video includes a visualization of the current high-level user input event that is automatically overlaid on top of the screencast video at the screen location where the current high-level user input event takes place, and a visualization of the next high-level user input event that is automatically overlaid on top of the screencast video at the screen location where the next high-level user input event takes place.

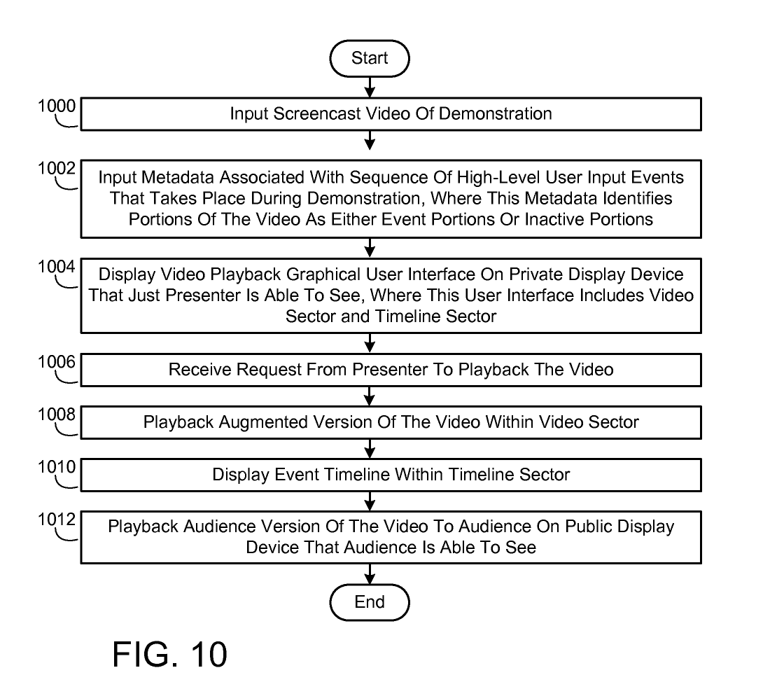

FIG. 10 illustrates an exemplary embodiment, in simplified form, of a process for allowing a presenter to re-perform a demonstration during a live presentation to an audience. As exemplified in FIG. 10, the process starts in block 1000 with inputting a screencast video of the demonstration. Metadata which is associated with the sequence of high-level user input events that takes place during the demonstration is then input, where this metadata identifies portions of the screencast video as either event portions or inactive portions (block 1002) as just described. A video playback GUI is then displayed on a private display device that just the presenter is able to see, where this GUI includes a video sector and a timeline sector (block 1004) as described heretofore. Upon receiving a request from the presenter to playback the screencast video (block 1006), an augmented version of the screencast video is played back within the video sector (block 1008), and an event timeline is displayed within the timeline sector (block 1010). As also described heretofore, the event timeline includes an overall timeline that shows each of the event portions and each of the inactive portions of the screencast video, and also shows any pause segments and any stop segments that have been inserted into the screencast video. The event timeline can also include the aforementioned current topic and next topic timelines. An audience version of the screencast video is also played back to the audience on a public display device that the audience is able to see (block 1012). As also described heretofore, the playback of the audience version is synchronized to the playback of the augmented version so that each of the portions of the audience version is played back synchronously with the corresponding portion of the augmented version.

### 2.0 Additional Embodiments

While the demonstration re-performing technique has been described by specific reference to embodiments thereof, it is understood that variations and modifications thereof can be made without departing from the true spirit and scope of the demonstration re-performing technique. By way of example but not limitation, a finer granularity of event portions of the screencast video can be identified by analyzing the inactive portions of the screencast video using either conventional computer vision techniques, or conventional video analysis techniques, or a combination thereof. Although the demonstration re-performing technique embodiments have been described in the context of the demonstration that is recorded in the screencast video being a software application demonstration that was originally performed on the display screen of a computer, the demonstration re-performing technique embodiments described herein can also support any other type of demonstration that can be performed on the display screen of a computer. Although the aforementioned various types of edits that the presenter can make to the playback of the screencast video during the rehearsal and editing phase of the workflow do not modify the screencast video itself, an alternate embodiment of the demonstration re-performing technique is possible where the screencast video itself can be edited using conventional video editing methods.

Furthermore, although the demonstration re-performing technique embodiments have been described in the context of the low-level user input events during the demonstration taking place via a conventional mouse and a conventional physical keyboard, it is noted that alternate embodiments of the demonstration re-performing technique are also possible where the low-level user input events can also take place via one or more natural user interface modalities. By way of example but not limitation, in the case where the display screen of the computer is touch-sensitive, the low-level user input events can also take place via various types of physical contact (e.g., taps, drags, and the like) on the display screen. In the case were the computer has a voice recognition capability, the low-level user input events can also take place via spoken commands. In the case where the computer has a gesture recognition capability, the low-level user input events can also take place via hand gestures (among other types of gestures).

Yet furthermore, rather than capturing a screencast video of the demonstration, a conventional video camera can be used to capture a video of the demonstration as it is being performed. A video analysis system can then be used to identify prescribed types of events that take place in the video and mark each of the identified events in the video. By way of example but not limitation, the video analysis system can detect when a person walks into a room, or when a person makes a certain gesture, or when a person is talking, or when a person opens a door. An alternate embodiment of the demonstration re-performing technique can then be used to annotate the marked video with visualizations of the identified events on-the-fly as the marked video is being played back.

Yet furthermore, rather than one or more consecutive mouse-wheel-down events that take place within the prescribed scrolling period of time being converted into a scroll-down event, and one or more consecutive mouse-wheel-up events that take place within this period of time being converted into a scroll-up event, such mouse-wheel-down events can be converted into a zoom-out event and such mouse-wheel-up events can be converted into a zoom-in event, or vice versa.

It is also noted that any or all of the aforementioned embodiments can be used in any combination desired to form additional hybrid embodiments. Although the demonstration re-performing technique embodiments have been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

### 3.0 Exemplary Operating Environments

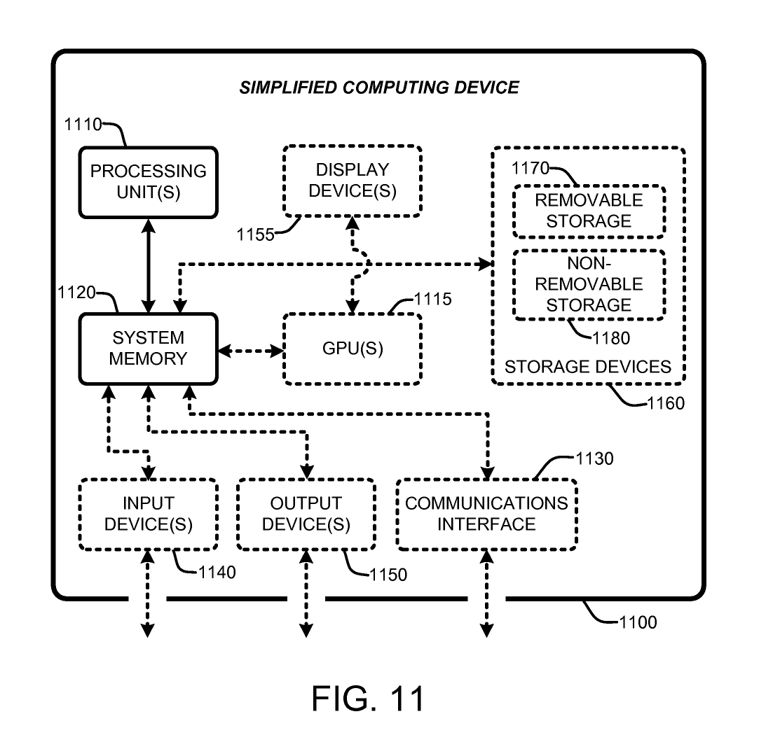

The demonstration re-performing technique embodiments described herein are operational within numerous types of general purpose or special purpose computing system environments or configurations. FIG. 11 illustrates a simplified example of a general-purpose computer system on which various embodiments and elements of the demonstration re-performing technique, as described herein, may be implemented. It is noted that any boxes that are represented by broken or dashed lines in the simplified computing device 1100 shown in FIG. 11 represent alternate embodiments of the simplified computing device. As described below, any or all of these alternate embodiments may be used in combination with other alternate embodiments that are described throughout this document. The simplified computing device 1100 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to implement the demonstration re-performing technique embodiments described herein, the device should have a sufficient computational capability and system memory to enable basic computational operations. In particular, the computational capability of the simplified computing device 1100 shown in FIG. 11 is generally illustrated by one or more processing unit(s) 1110, and may also include one or more graphics processing units (GPUs) 1115, either or both in communication with system memory 1120. Note that that the processing unit(s) 1110 of the simplified computing device 1100 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 1100 shown in FIG. 11 may also include other components such as a communications interface 1130. The simplified computing device 1100 may also include one or more conventional computer input devices 1140 (e.g., pointing devices, keyboards, audio (e.g., voice) input devices, video input devices, haptic input devices, gesture recognition devices, devices for receiving wired or wireless data transmissions, and the like). The simplified computing device 1100 may also include other optional components such as one or more conventional computer output devices 1150 (e.g., display device(s) 1155, audio output devices, video output devices, devices for transmitting wired or wireless data transmissions, and the like). Note that typical communications interfaces 1130, input devices 1140, output devices 1150, and storage devices 1160 for general-purpose computers are well known to those skilled in the art, and will not be described in detail herein.

The simplified computing device 1100 shown in FIG. 11 may also include a variety of computer-readable media. Computer-readable media can be any available media that can be accessed by the computer 1100 via storage devices 1160, and can include both volatile and nonvolatile media that is either removable 1170 and/or non-removable 1180, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), compact discs (CDs), floppy disks, tape drives, hard drives, optical drives, solid state memory devices, random access memory (RAM), read-only memory (ROM), electrically erasable programmable read-only memory (EEPROM), flash memory or other memory technology, magnetic cassettes, magnetic tapes, magnetic disk storage, or other magnetic storage devices.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various demonstration re-performing technique embodiments described herein, or portions thereof, may be stored, received, transmitted, or read from any desired combination of computer-readable or machine-readable media or storage devices and communication media in the form of computer-executable instructions or other data structures.

Finally, the demonstration re-performing technique embodiments described herein may be further described in the general context of computer-executable instructions, such as program modules, being executed by a computing device. Generally, program modules include routines, programs, objects, components, data structures, and the like, that perform particular tasks or implement particular abstract data types. The demonstration re-performing technique embodiments may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Wherefore, what is claimed is:

1. A computer-implemented process for identifying user input events in a screencast video of a demonstration, comprising:
using a computer to perform the following process actions:
inputting the screencast video;
inputting data associated with a sequence of low-level user input events that takes place during the demonstration;
converting the sequence of low-level user input events into a sequence of high-level user input events; and
identifying portions of the screencast video as either event portions or inactive portions, said identification comprising the actions of,
mapping each of the high-level user input events to a different event portion, and
mapping each gap in time that exists between two consecutive high-level user input events to a different inactive portion.

2. The process of claim 1, wherein the sequence of low-level user input events comprises a mouse-button-down mouse-button-up event sequence that takes place at substantially the same screen location, and the process action of converting the sequence of low-level user input events into a sequence of high-level user input events comprises an action of converting said mouse-button-down mouse-button-up event sequence into a single-click event.

3. The process of claim 1, wherein the sequence of low-level user input events comprises a mouse-button-down mouse-button-up mouse-button-down mouse-button-up event sequence that takes place at substantially the same screen location within a prescribed double-click period of time, and the process action of converting the sequence of low-level user input events into a sequence of high-level user input events comprises an action of converting said mouse-button-down mouse-button-up mouse-button-down mouse-button-up event sequence into a double-click event.

4. The process of claim 1, wherein the sequence of low-level user input events comprises a mouse-button-down mouse-button-up event sequence that takes place at two different screen locations, and the process action of converting the sequence of low-level user input events into a sequence of high-level user input events comprises an action of converting said mouse-button-down mouse-button-up event sequence into a drag event.

5. The process of claim 1, wherein either,
the sequence of low-level user input events comprises one or more consecutive mouse-wheel-down events that take place within a prescribed scrolling period of time, and the process action of converting the sequence of low-level user input events into a sequence of high-level user input events comprises an action of converting said mouse-wheel-down events into a scroll-down event, or
the sequence of low-level user input events comprises one or more consecutive mouse-wheel-up events that take place within the prescribed scrolling period of time, and the process action of converting the sequence of low-level user input events into a sequence of high-level user input events comprises an action of converting said mouse-wheel-up events into a scroll-up event.

6. The process of claim 1, wherein the sequence of low-level user input events comprises one or more consecutive key-press events that take place within a prescribed text-entry period of time, and the process action of converting the sequence of low-level user input events into a sequence of high-level user input events comprises an action of converting said key-press events into a keystroke event.

7. The process of claim 1, wherein the process action of identifying portions of the screencast video as either event portions or inactive portions further comprises an action of storing metadata for each of the portions of the screencast video, said metadata comprising:
the duration of the portion;
an indicator specifying whether the portion is an event portion or an inactive portion; and
whenever the portion is an event portion, another indicator specifying the particular high-level user input event that is mapped to the portion.

8. A computer-implemented process for allowing a presenter to rehearse and edit a demonstration, comprising:
using a computer comprising a display device to perform the following process actions:
inputting a screencast video of the demonstration;
inputting metadata associated with a sequence of high-level user input events that takes place during the demonstration, said metadata identifying portions of said video as either event portions or inactive portions, each of the high-level user input events being mapped to a different event portion, and each gap in time that exists between two consecutive high-level user input events being mapped to a different inactive portion;
inputting metadata associated with each of the portions;
receiving a request from the presenter to playback the screencast video; and
playing back an augmented version of the screencast video to the presenter on the display device, said augmented version being generated on-the-fly as the screencast video is being played back, during at least one point in time during said playback said augmented version comprising a visualization of the current high-level user input event that is automatically overlaid on top of the screencast video at the screen location where the current high-level user input event takes place, and a visualization of the next high-level user input event that is automatically overlaid on top of the screencast video at the screen location where the next high-level user input event takes place.

9. The process of claim 8, wherein,
whenever the current high-level user input event comprises a single-click event, the visualization of the current high-level user input event comprises a single-click glyph,
whenever the current high-level user input event comprises a double-click event, the visualization of the current high-level user input event comprises a double-click glyph,
whenever the current high-level user input event comprises a drag event, the visualization of the current high-level user input event comprises a drag glyph, the starting-point of the drag glyph being overlaid on top of the screencast video at the start-location of the drag event and the terminus of the drag glyph being overlaid on top of the screencast video at the end-location of the drag event,
whenever the current high-level user input event comprises a scroll event, the visualization of the current high-level user input event comprises a scroll glyph, and
whenever the current high-level user input event comprises a keystroke event comprising one or more consecutive key-press events, the visualization of the current high-level user input event comprises a keystroke glyph comprising said key-press events.

10. The process of claim 8, wherein,
whenever the next high-level user input event comprises a single-click event, the visualization of the next high-level user input event comprises a single-click glyph,
whenever the next high-level user input event comprises a double-click event, the visualization of the next high-level user input event comprises a double-click glyph,
whenever the next high-level user input event comprises a drag event, the visualization of the next high-level user input event comprises a drag glyph, the starting-point of the drag glyph being overlaid on top of the screencast video at the start-location of the drag event and the terminus of the drag glyph being overlaid on top of the screencast video at the end-location of the drag event,
whenever the next high-level user input event comprises a scroll event, the visualization of the next high-level user input event comprises a scroll glyph, and
whenever the next high-level user input event comprises a keystroke event comprising one or more consecutive key-press events, the visualization of the next high-level user input event comprises a keystroke glyph comprising said key-press events.

11. The process of claim 8, wherein the augmented version of the screencast video that is played back to the presenter further comprises a motion-arrow glyph that is automatically overlaid on top of the screencast video between the visualization of the current high-level user input event and the visualization of the next high-level user input event, a starting-point of the motion-arrow glyph being placed either at or near the screen location where the current high-level user input event ends, and a terminus of the motion-arrow glyph being placed either at or near the screen location where the next high-level user input event starts.

12. The process of claim 11, wherein the motion-arrow glyph comprises:
a straight motion-arrow glyph whenever the screen location where the current high-level user input event ends is greater than or equal to a prescribed long distance away from the screen location where the next high-level user input event starts;
a round motion-arrow glyph whenever the screen location where the current high-level user input event ends is less than or equal to a prescribed short distance away from the screen location where the next high-level user input event starts, said short distance being significantly less than said long distance; and
a curved motion-arrow glyph whenever the screen location where the current high-level user input event ends is less than said long distance and greater than said short distance away from the screen location where the next high-level user input event starts.

13. The process of claim 11, wherein the motion-arrow glyph comprises a progress bar that is embedded there-within, said progress bar visually indicating to the presenter the proportional amount of time that remains until the next high-level user input event starts.

14. The process of claim 8, further comprising the actions of:
receiving a request from the presenter to group a specific sequence of portions of the screencast video into a topic;
receiving a text label for the topic that is specified by the presenter; and
revising the metadata for each of the portions in said specific sequence to indicate that the portion is part of the topic having the text label.

15. The process of claim 8, further comprising the actions of:
receiving a request from the presenter to adjust the playback speed of a specific portion of the screencast video; and
revising the metadata for the specific portion to indicate that said portion is to be played back at said adjusted speed.

16. The process of claim 8, further comprising the actions of:
receiving a request from the presenter to insert either a pause segment having a specified length of time or a stop segment into a specific portion of the screencast video; and
revising the metadata for the specific portion to indicate that said portion comprises either said pause or stop segments.

17. The process of claim 8, further comprising the actions of:
receiving a request from the presenter to insert a text note into a specific portion of the screencast video at a desired screen location; and
revising the metadata for the specific portion to indicate that said portion comprises the text note and that a visualization of the text note is to be automatically overlaid on top of said video at the desired screen location.

18. The process of claim 8, further comprising the actions of:
receiving a request from the presenter to hide a specific portion of the screencast video; and
revising the metadata for the specific portion to indicate that said portion is to be hidden during the playback of said video.

19. In a computer system comprising a user interface comprising a private display device that just a presenter is able to see, a computer-implemented process for allowing the presenter to re-perform a demonstration during a live presentation to an audience, comprising:
using the computer to perform the following process actions:
inputting a screencast video of the demonstration;
inputting metadata associated with a sequence of high-level user input events that takes place during the demonstration, said metadata identifying portions of the screencast video as either event portions of inactive portions, each of the high-level user input events being mapped to a different event portion, and each gap in time that exists between two consecutive high-level user input events being mapped to a different inactive portion;
displaying a video playback graphical user interface (GUI) on the private display device, the GUI comprising a video sector and a timeline sector;
receiving a request from the presenter to playback the screencast video;
playing back an augmented version of the screencast video within the video sector, during at least one point in time during said playback said augmented version comprising a visualization of the current high-level user input event and a visualization of the next high-level user input event; and
displaying an event timeline within the timeline sector, the event timeline comprising an overall timeline showing each of the event portions and each of the inactive portions of the screencast video.

20. The process of claim 19, the computer system further comprising a public display device that the audience is able to see, further comprising an action of playing back an audience version of the screencast video to the audience on the public display device, said playback being synchronized to the playback of the augmented version of the screencast video so that each of the portions of said audience version is played back synchronously with the corresponding portion of said augmented version, said audience version being either a non-augmented version of the screencast video, or said augmented version.
